(19) United States
(12) Patent Application Publication
(10) Pub. No.: US 2026/0184588 A1
(43) Pub. Date: Jul. 2, 2026

(54) METHODS FOR PRODUCTION OF PRECIPITATED CALCIUM CARBONATE (PCC) AND PCC PRODUCT

(71) Applicant: SPECIALTY MINERALS (MICHIGAN) INC., Plymouth, MI (US)

(72) Inventors: Haiyang GAO, Jining (CN); Bo GAO, Suzhou (CN); Xianzhong GAO, Zhenjiang (CN)

(21) Appl. No.: 19/548,843

(22) Filed: Feb. 24, 2026

Related U.S. Application Data
(63) Continuation of application No. PCT/CN2023/118744, filed on Sep. 14, 2023.

(51) Int. Cl. C01F 11/18; D21H 17/67

(52) U.S. Cl. CPC C01F 11/18; D21H 17/675; C01P 2004/61

(57) ABSTRACT

A method for making precipitated calcium carbonate (PCC) is provided. The process includes adding a PCC additive or PCC seed to the process prior to the carbonation of the slaked lime to form precipitate calcium carbonate.

### CROSS REFERENCE TO RELATED APPLICATION

This application is a continuation of International Application PCT/CN2023/118744 filed on Sep. 14, 2023, which has been incorporated herein by reference in its entirety.

### FIELD

The present inventions relate to methods for producing precipitated calcium carbonate (PCC). Moreover, the inventions relate to an aqueous suspension of PCC, the produced PCC, and products made from the produced PCC. More particularly, the inventions relate to a process of adding PCC seed or additive to the process prior to the carbonation of the slaked lime to produce PPC having larger particle sizes.

### BACKGROUND

Precipitated calcium carbonate (PCC), having the chemical formula of CaCO₃, exists in three primary crystalline forms: calcite, aragonite, and vaterite. PCC can harbor many different polymorphs. The crystal habits can include scalenohedral, rhombohedral, hexagonal prismatic, cubic, and prismatic. PCC is prepared by introducing CO₂ into an aqueous suspension of calcium hydroxide (Ca(OH)₂), which is commonly referred to as “milk of lime”:

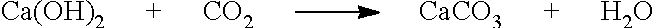

PCC is used extensively in the paper industry. PCC is inexpensive and is used as a bulk enhancing material. PCC increases paper's brightness, opacity, and can add strength to the paper product. Thus, PCC is considered an excellent filler material for paper and paperboard. PCC with relatively larger particle sizes can yield better strength and improve bulk, especially for uncoated wood free (“UCWF”) paper. Current methods of producing PCC with larger particle sizes have shown to be inefficient, expensive, and fail to achieve particle size growth that is needed. The embodiments of the present inventions are directed at efficient and cost-effective methods of manufacturing large sized PCC particles.

### SUMMARY

In accordance with one embodiment of the inventions a method for making precipitated calcium carbonate (PCC) is provided. The method can comprise combining constituents comprising calcium oxide and water to prepare a slurry comprising calcium hydroxide; adding PCC seed to the slurry comprising the calcium hydroxide to form a resultant comprising the PCC seed and the calcium hydroxide; and conducting a carbonation process of the resultant comprising the PCC seed and the calcium hydroxide to form a suspension comprising PCC. The total amount of the PCC seed added to the slurry comprising calcium hydroxide can be in an amount ranging from greater than 2.5 volume % to less than 30 volume %. The suspension comprises the PCC having a weight median diameter d₅₀ of at least 2.0 μm. The carbonation process comprises adding a carbon dioxide generating material to the resultant comprising the PCC seed and the calcium hydroxide. The method can additionally comprise separating the PCC from the suspension; and drying the separated solids to form dry PCC. The dry PCC can be used as the PCC seed. The PCC seed can be mixed with the slurry comprising the calcium hydroxide for greater than 0 minutes to 60 minutes or less, after which time the carbonation process is initiated.

In accordance with another embodiment, a method of producing large sized PCC particles is provided. The method comprises manufacturing produced PCC particles; adding an amount of the produced PCC particles as an additive to a milk of lime; and carbonating the milk of lime having the PCC additive to make finalized PCC particles having larger sizes than the produced PCC particles. 2.5% to 30% of the produced PCC particles can be recycled back and added to the milk of lime as the PCC additive. The produced PCC particles added as the additive to the milk of lime can be in dry particle form. The produced PCC particles added as the additive to the milk of lime can be in an aqueous suspension. The method can include screening the produced PCC particles to yield the additive having a selected sized particle prior to being added to the milk of lime. In one variation, PCC particles are not screened to yield an additive having a selected sized particle prior to being added to the milk of lime. The total amount of the PCC additive added to the milk of lime is in an amount ranging from greater than 2.5 volume % to less than 30 volume % of the total volume of the composition. The finalized PCC particles can have a weight median diameter d₅₀ of at least 2.0 μm. The finalized PCC particles can have a weight median diameter d₅₀ of 2.8 μm to 3.1 μm. The PCC additive is allowed to mix with the a milk of lime for 60 minutes or less after which time the carbonating the milk of lime is initiated.

A paper product comprising the PCC can be made from the process described above.

### BRIEF DESCRIPTION OF THE DRAWINGS

FIG. 1 is a basic flow diagram for a process of making precipitated calcium carbonate (PCC) in accordance with one embodiment of the inventions.

FIG. 2 illustrates the components for the process of making precipitated calcium carbonate (PCC) in accordance with one embodiment of the inventions.

FIG. 3 is a graph illustrating mass frequency versus PCC particle diameter of the Example 1.

### DESCRIPTION

As used herein, precipitated calcium carbonate (PCC) takes its ordinary chemistry definition having a chemical formula of CaCO₃. PCC has three primary crystalline forms: calcite, aragonite and vaterite. It can also include a variety of different polymorphs or crystal habits for each of these crystalline forms. For the embodiments of the present inventions, the crystal habit can preferably be, for example, a scalenohedral (S-PCC).

As used herein, calcium hydroxide takes its ordinary chemistry definition having a chemical formula of Ca(OH)₂. Calcium hydroxide has traditionally been referred to as “slaked lime” or “milk of lime.” Slake, slaked lime, milk of lime, and slurry having calcium hydroxide are terms that are used interchangeably herein. Slaked lime is produced when calcium oxide or quicklime is mixed or slaked with water, or is hydrated. Calcium hydroxide has many other names including hydrated lime, caustic lime, builders' lime, and pickling lime. The slake can be a calcium hydroxide slurry, such as an aqueous calcium hydroxide suspension and can, for example, have a solids content of less than 40% by weight.

As used herein, calcium oxide takes its ordinary chemical definition having a chemical formula of CaO. Calcium oxide, is commonly known as lime or quicklime and is an alkaline substance.

As used herein, calcium oxide containing compound or material is a material having at least 40 wt % calcium oxide based on the total weight of the material. Preferably, the content would be at least 70 wt %, and more preferably at least 90%.

As used herein, a slurry is a mixture of solids suspended in liquid, usually water. The suspension can include insoluble solids, water, and optionally additives.

As used herein, carbon dioxide generating compound or material can include, and is not limited to, for example, gaseous carbon dioxide, liquid carbon dioxide, solid carbon dioxide, a gas or liquid containing carbon dioxide (e.g., Na₂CO₃, K₂CO₃, etc.), pure gaseous carbon dioxide, and a flue gas containing carbon dioxide. The carbon dioxide generating compound can be a gaseous mixture of carbon dioxide and air or carbon dioxide and nitrogen.

As used herein, the carbonation process (or carbonating) refers to the process of converting calcium hydroxide into PCC. The conversion can take place by adding or supplying a quantity or volume (e.g., kg CO₂/minute per kg of dry Ca(OH)₂) of carbon dioxide generating compound to the slake in a reaction vessel or carbonator. The completion of the carbonation process can extend after the completion of the addition of the carbon dioxide generating compound and the addition of the carbon dioxide generating compound can be continuous or intermittent.

As used herein, PCC additive or PPC seed, terms which are used interchangeably, can comprise (or consist essentially of, or consist of) PCC particles produced by the carbonation process. The PPC seed/additive can be the PCC particles in an aqueous suspension. The PCC seed/additive can also be removed or separated from the aqueous suspension and can be in the form of dry particles. The PCC particles produced by the carbonation process can also be screened for size to yield a PPC seed/additive of a selected size. In another embodiment, the PCC particles produced by the carbonation process is not screened for size for use as the seed/additive.

As used herein, an aqueous suspension refers to a system where the liquid phase comprises, consists essentially of, or consists of water. The term can encompass water in combination with minor amounts of a water-miscible organic solvent, such as methanol, ethanol, acetone, acetonitrile, tetrahydrofuran, and combinations thereof.

As used herein, dry form means separating the produced PCC particles from the resultant aqueous suspension and drying the PCC particles. The dry PCC can be completely dry or can be essentially dry—that is, with residual amount of water being present (for example, less than 3%, preferably less than 1% by volume of water).

As used herein, particle size refers to weight-based distribution of particle size dx. The value of dx represents the diameter relative to which x % by weight of the particles have diameters less than dx. Particle size values disclosed herein are measured by sedigraph particle size analysis as is well known in the art.

As used herein, solid content of a liquid composition refers to the amount of solid material, in weight % or volume %, remaining after all of the solvent and/or water has been removed and/or evaporated.

As used herein, the singular forms “a”, “an,” and “the” are intended to include the plural forms and plural is intended to include singular, unless the context clearly indicates otherwise (such as, for example, with the use of the term “one” or “plurality”). For example, reaction content can include more than one content.

As used herein, the term “and/or” includes one or any combinations of one or more of the associated listed items.

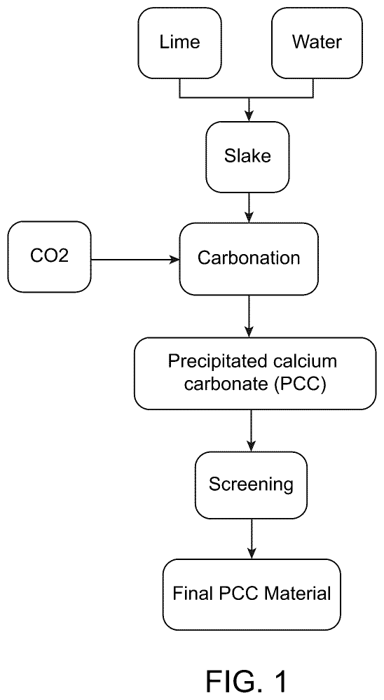

FIG. 1 is a basic, schematic flow diagram of producing precipitated calcium carbonate (PCC) in accordance with one embodiment. Calcium oxide (lime or quicklime) is mixed or slaked with water, or is hydrated, to produce milk of lime. The slake is carbonated to produce an aqueous suspension of PCC. An amount of the aqueous suspension of PCC, used as the seed or additive, can be continuously or intermittently added to, or recycled into the process prior to the initiation of the carbonation process. The PCC particles suspended in the aqueous solution can also be screened to yield particles of a selected size prior to adding or recycling the aqueous suspension into the process.

The methods of the embodiments of the present inventions can also include removing or filtering (e.g., dehydrating) the PCC particles from the aqueous suspension, optionally separating (e.g., screening) particles to yield particles of a selected size, and optionally drying the PCC particles or the separated PCC particles. The screening step can be performed before or after the dehydrating step. The removing, optional separating, and optional drying steps can be used to form the PCC seed. An amount of the removed, optionally separated, and/or optionally dried PCC seed can be continuously or intermittently added to or recycled into the process prior to the initiation of the carbonation process.

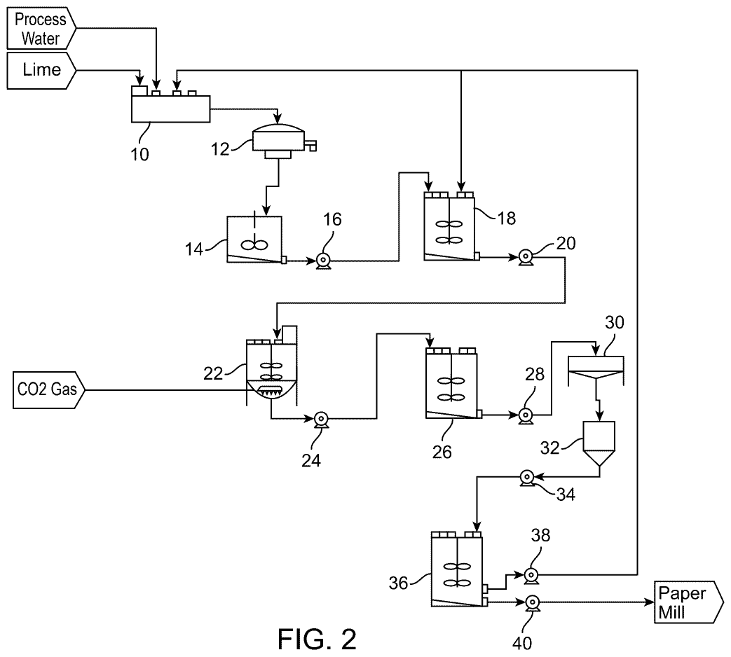

FIG. 2 illustrates an embodiment of the components for making precipitated calcium carbonate (PCC). Calcium oxide containing material is hydrated. That is, quicklime and water can be combined in a slaker 10 to form a slake or a slurry having calcium hydroxide. The slake can be screened in a slake screen 12 to remove particles of undesirable sizes. The slake can be transported to a slake surge tank 14 and pumped, by a slake surge pump 16, into a slake hold tank 18. A slake transfer pump 20 can transfer the slake to a carbonator 22. A carbon dioxide generating material is introduced into the carbonator 22 for the carbonation process. An aqueous suspension of PCC is produced. The aqueous PCC suspension can be transferred via a transfer pump 24 to a prescreen tank 26. A prescreen pump 28 can transfer the PCC suspension to a product screen 30, where the PCC is screened to filter particles of predetermined sizes. The screened PCC can be stored in a post screen tank 32, after which a post screen pump 34 can transfer the PCC suspension into a product storage tank 36.

Next, the process includes using the produced PCC as an additive or seed by adding the PCC back to the slaker 10, or the slake holding tank 18, and/or the slake surge tank 14. That is, an amount PCC seed is added to the slaked lime or milk of lime before the initiation of the carbonation process. A seed metering pump 38 can add the PCC back to the slaker 10, the slake holding taking 18, and/or the slake surge tank 14. The mixing or blending time of the PCC seed with the slaked lime can be from greater than 0 minutes to 60 minutes, after which time the carbonation process is initiated. In one embodiment, the blending time is less than 60 minutes. In one embodiment, the mixing time is from 15 minutes to 50 minutes.

In one embodiment, the PCC seed can be added to the carbonator 22. Here too the mixing or blending time of the PCC seed with the slaked lime can be from greater than 0 minutes to 60 minutes, after which time the carbonation process is initiated. In one embodiment, the blending time is less than 60 minutes. In one embodiment, the mixing time is from 15 minutes to 50 minutes. The PCC seed is allowed to mix or blend with the slaked lime before initiation of the carbonation. In one alternative embodiment, addition of PCC seed and initiating of carbonation can be simultaneous.

In another embodiment, PCC particles from the prescreen tank 26 can be added to the slaked lime as the additive. For example, PCC particles from the prescreen tank can be added back to the slaker 10, the slake holding tank 18, the slake surge tank 14, and/or the carbonator 22.

In one embodiment, greater than 0% to 40%, and more preferably 2.5% to 30% of the produced PCC is recycled back to the slaked lime as the additive (e.g., back to the slaker 10, the slake holding tank 18, the slake surge tank 14, and/or the carbonator 22). In one preferred embodiment, the amount added can be less than 10%. In one embodiment, the total amount of the PCC seed added to the slaked lime can be in an amount ranging from greater than 2.5 volume % to less than 30 volume %, preferably from 10 volume % to volume %, based on the total weight of the composition.

The PCC seed or additive added to the slaked lime (e.g., back to the slaker 10, the slake holding tank 18, the slake surge tank 14, and/or the carbonator 22) can have a weight median diameter d₅₀ of at least 1.0 μm. The addition of PCC seed prior the carbonation step can produce PCC having a weight median diameter d₅₀ of 1.0 μm to 3.2 μm, more preferably 1.4 μm to 3.0 μm. In one embodiment, weight median diameter d₅₀ is at least 2.0 μm, preferably 2.8 μm or larger, and can be 2.8 μm to 3.1 μm. Accordingly, larger PCC sized particles can be produced as compared the PCC produced without the use of PCC seed or additive.

PCC particles having larger sizes, as compared to if the PCC was not used as an additive, can then be transferred out by the product transfer pump 40 for end use.

The PCC made by the processes of the present inventions can be used for paper (herein intended to include paperboard and all paper products). The PCC made by the processes of the present inventions can also be used for consumable goods including, but not limited to coatings, paints, rubbers, plastics, polymers, building materials, ink, food, cosmetics, agricultural products, drugs, and pharmaceuticals.

It is further understood that a variety of additives can be added prior to, during, or after the carbonation process. For example, the additives can be added to the milk of lime. The additive can be, for example a slaking additive or a precipitation additive. Examples of additives include sugar, citric acid, potassium, sodium, and other additives well known in the art. Moreover, the processes of the present inventions can be performed in batch, semi-batch, or continues mode. The continuous mode can be in a continuous tube reactor or several separate carbonators (pH of suspension is gradually reduced from the first carbonator to the last carbonator).

### Example 1

Finished PCC seed was added to the slake.

| | | | | | | | | Slake | |
|---|---|---|---|---|---|---|---|---|---|
| | | | PCC | | Seeds | Seed % | Seed/slake | Viscosity | Sedigraph |
| | Lime | Batch | Seed | Slake | d₅₀ | (volume/ | blending | (20 rpm, | d₅₀ |
| No. | source | Number | (ml) | (ml) | (μm) | volume) | Time (min) | cps) | (μm) |
| 1 | Desheng | 5466-15 | 300 | 1700 | 2.90 | 15.0 | 60 | 48 | 2.84 |
| 2 | Desheng | 5466-17 | 300 | 1700 | 2.90 | 15.0 | 30 | 58 | 3.02 |
| 3 | Desheng | 5466-19 | 300 | 1700 | 2.80 | 15.0 | 15 | 12 | 2.90 |
| 4 | Desheng | 5466-21 | 300 | 1700 | 2.90 | 15.0 | 60 | 4540 | 3.06 |
| 5 | Desheng/ | 5466-23 | 300 | 1700 | 2.90 | 15.0 | 15 | 1320 | 2.93 |
| | Huibin | | | | | | | | |
| | 1:2 | | | | | | | | |
| 6 | Desheng/ | 5466-25 | 300 | 1700 | 2.90 | 15.0 | 15 | 4210 | 2.95 |
| | Huibin | | | | | | | | |
| | 1:2 | | | | | | | | |

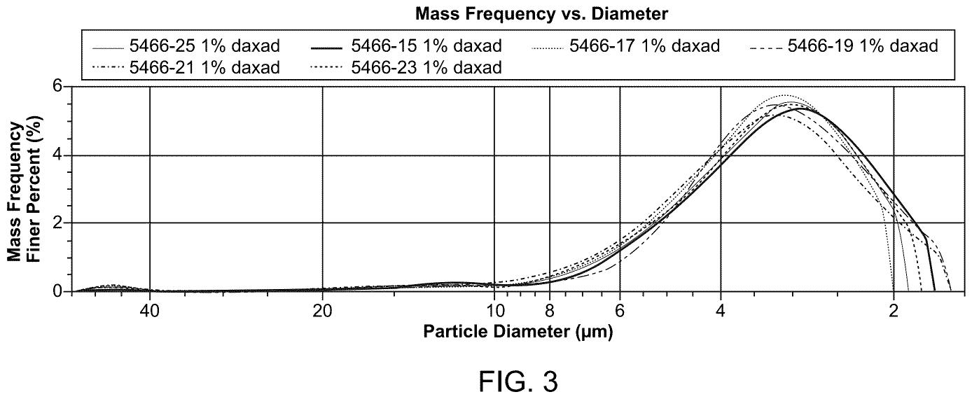

FIG. 3 illustrates the mass frequency versus particle diameter of the PCC produced. The sedigraph PSD distribution shows a single peak.

### Example 2

Finished PCC seed was added to the carbonator.

| | | | % Seed | | | |
|---|---|---|---|---|---|---|
| | | | seed | | | |
| | | | volume/ | | | |
| | | | (seed | Seed | | Product |
| | | Seed + | volume + | Sedigraph | Seed | Sedigraph |
| | Seed | Slake | slake | d₅₀ | addition | d₅₀ |
| No. | (m³) | (m³) | volume) | (μm) | point | (μm) |
| 1 | 10 | 57 | 17.5 | 2.79 | Carb | 3.28 |
| | | | | | (premix | |
| | | | | | 15 min) | |
| 2 | 10.6 | 60.9 | 17.4 | 2.79 | Carb | 3.60 |
| | | | | | (premix | |
| | | | | | 60 min) | |
| 3 | 8.4 | 60 | 14.0 | 2.79 | Carb | 2.94 |
| | | | | | (premix | |
| | | | | | 15 min) | |
| 4 | 7.5 | 57 | 13.2 | 2.78 | Carb | 2.82 |
| | | | | | (premix | |
| | | | | | 0 min) | |

While several particular forms, variations, and embodiments of the inventions have been illustrated and described, it will also be apparent that various modifications can be made without departing from the scope of the inventions. It is also contemplated that various combinations or sub-combinations of the specific features and aspects of the disclosed embodiments can be combined with or substituted for one another in order to form varying modes of the inventions.

What is claimed is:

1. A method for making precipitated calcium carbonate (PCC), the method comprising:
(a) combining constituents comprising calcium oxide and water to prepare a slurry comprising calcium hydroxide;
(b) adding PCC seed to the slurry comprising the calcium hydroxide to form a resultant comprising the PCC seed and the calcium hydroxide; and
(c) conducting a carbonation process of the resultant comprising the PCC seed and the calcium hydroxide to form a suspension comprising PCC.

2. The method of claim 1, wherein the total amount of the PCC seed added to the slurry comprising calcium hydroxide is in an amount ranging from greater than 2.5 volume % to less than 30 volume % of the total volume of the composition.

3. The method of claim 1, wherein the suspension comprises PCC having a weight median diameter d₅₀ of at least 2.0 μm.

4. The method of claim 1, wherein the suspension comprises PCC having a weight median diameter d₅₀ of 2.8 μm to 3.1 μm.

5. The method of claim 1, wherein the conducting of the carbonation process comprises adding a carbon dioxide generating material to the resultant comprising the PCC seed and the calcium hydroxide.

6. The method claim 1, additionally comprising:
(d) separating the PCC from the suspension; and
(e) drying the separated solids to form dry PCC.

7. The method of claim 6, wherein the dry PCC is used as the PCC seed.

8. The method of claim 1, wherein the PCC seed is mixed with the slurry comprising the calcium hydroxide for 60 minutes or less after which time the carbonation process is initiated.

9. A paper product comprising the PCC made from the process according to claim 1.

10. A method of producing large sized PCC particles, comprising:
manufacturing produced PCC particles;
adding an amount of the produced PCC particles as an additive to a milk of lime; and
carbonating the milk of lime having the PCC additive to make finalized PCC particles having larger sizes than the produced PCC particles.

11. The method of claim 10, wherein 2.5% to 30% of the produced PCC particles are recycled back and added to the milk of lime as the PCC additive.

12. The method of claim 10, wherein the produced PCC particles added as the additive to the milk of lime are in dry particle form.

13. The method of claim 10, wherein the produced PCC particles added as the additive to the milk of lime are in an aqueous suspension.

14. The method of claim 10, additionally comprising screening the produced PCC particles to yield the additive having a selected sized particle prior to being added to the milk of lime.

15. The method of claim 10, wherein the PCC particles are not screened to yield an additive having a selected sized particle prior to being added to the milk of lime.

16. The method of claim 10, wherein the total amount of the PCC additive added to the milk of lime is in an amount ranging from greater than 2.5 volume % to less than volume % of the total volume of the composition.

17. The method of claim 10, wherein the finalized PCC particles have a weight median diameter d₅₀ of at least 2.0 μm.

18. The method of claim 10, wherein the finalized PCC particles have a weight median diameter d₅₀ of 2.8 μm to 3.1 μm.

19. The method of claim 10, wherein the PCC additive is allowed to mix with the a milk of lime for 60 minutes or less after which time the carbonating the milk of lime is initiated.

20. A paper product comprising the PCC made from the process according to claim 10.
